(19) United States
(12) Patent Application Publication
(10) Pub. No.: US 2008/0093921 A1
(43) Pub. Date: Apr. 24, 2008

(54) Device for actuating shoe brakes, particularly for rail or tram vehicles

(75) Inventor: Roland Alfred Di Centa, London (GB)

Correspondence Address: MODIANO & ASSOCIATI, VIA MERAVIGLI, 16, MILAN, 20123, omitted

(73) Assignee: CTO SOLUTIONS INC.

(21) Appl. No.: 11/584,675

(22) Filed: Oct. 23, 2006

(51) Int. Cl. B60T 8/78

(52) U.S. Cl. 303/199

(57) ABSTRACT

A device for actuating shoe brakes, particularly for rail or tram vehicles, comprising elements for actuating at least one brake shoe of a rail or tram vehicle, powered by battery voltage and powered by a bank of supercapacitors arranged in parallel to the actuation elements, the bank of supercapacitors being controlled and charged by a dedicated circuit, which is connected to the battery, insulation elements being provided in order to insulate the actuation elements from the battery when the actuation elements are powered by the discharge of the bank of supercapacitors.

The present invention relates to a device for actuating shoe brakes, particularly for rail or tram vehicles. More particularly, the invention relates to a device for actuating shoe brakes for rail or tram vehicles that is capable of overcoming critical mechanical and electrical aspects of the shoe brakes currently installed for example on trams.

### BACKGROUND OF THE INVENTION

As is known, rail or tram vehicles, such as for example trams, are provided with shoe brakes, which act on the tracks on which the tram travels.

Known types of shoe brakes, and in particular the actuation circuits of said brakes, are affected by drawbacks of a mechanical and electrical type.

In particular, the proximity of the shoe to other mechanical parts causes flux leakage with respect to the track, and this forces to keep a very small distance between the shoe and the track, with risks of collision along the line.

Moreover, the shoe brakes are powered by the onboard battery, which can be insufficient if the battery charger is off.

Moreover, with known types of shoe brakes it is necessary to carry the power supply to the shoe with cables that have a rather large cross-section, and the batteries of the vehicle are stressed considerably, especially in the brake engagement step.

### SUMMARY OF THE INVENTION

The aim of the present invention is to provide a device for actuating shoe brakes, particularly for rail or tram vehicles, that allows to render the engagement of the brakes independent of the voltage of the onboard battery of the vehicle, thus reducing the stress affecting the battery and increasing braking performance.

Within this aim, an object of the present invention is to provide a device for actuating shoe brakes that allows to keep a greater distance between the shoe of the brakes and the track on which the vehicle travels.

Another object of the present invention is to provide a device for actuating shoe brakes that allows to reduce the cross-section of the cables that supply power to the brake shoes.

Another object of the present invention is to provide a device for actuating shoe brakes that allows to introduce in the brake release step a sequence for demagnetizing the shoe in order to facilitate separation from the track.

Another object of the present invention is to provide a device for actuating shoe brakes that allows to provide a stiffer size of the springs that allow to separate the shoe from the track, thus achieving safer disengagement of the shoe from said track.

Another object of the present invention is to provide a device for actuating shoe brakes particularly for rail or tram vehicles that is highly reliable, relatively simple to provide and at competitive costs.

This aim and these and other objects, which will become better apparent hereinafter, are achieved by a device for actuating shoe brakes, particularly for rail or tram vehicles, comprising means for actuating at least one brake shoe of a rail or tram vehicle, powered by battery voltage and powered by a bank of supercapacitors arranged in parallel to said actuation means, said bank of supercapacitors being controlled and charged by a dedicated circuit, which is connected to said battery, insulation means being provided in order to insulate said actuation means from said battery when said actuation means are powered by the discharge of said bank of supercapacitors.

### BRIEF DESCRIPTION OF THE DRAWING

Further characteristics and advantages of the invention will become better apparent from the description of a preferred but not exclusive embodiment of the device according to the present invention, illustrated by one of non-limiting example in the accompanying drawing, wherein the only FIGURE is a circuit diagram of the device according to the present invention.

### DESCRIPTION OF THE PREFERRED EMBODIMENTS

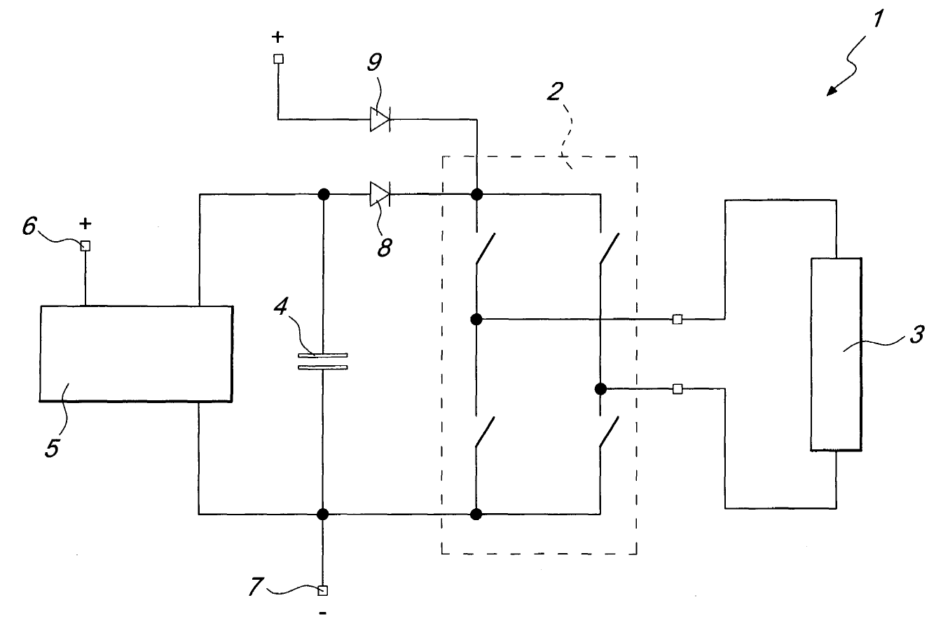

With reference to FIG. 1, the device for actuating shoe brakes, particularly for rail or track vehicles, generally designated by the reference numeral 1, comprises means 2 for actuating at least one shoe 3, said actuation means being constituted conveniently for example by a bridge formed by static switches, such as MOSFETs or IGBTs.

The bridge of static switches is powered by a bank of supercapacitors 4, which are arranged in parallel to the bridge and are controlled and charged by a dedicated circuit 5, which is connected directly to the positive battery voltage 6.

The actuation means are further connected to the battery of the vehicle with the interposition of insulation means conveniently constituted for example by at least one diode 9.

The bank of supercapacitors 4 is further connected to the negative terminal of the battery 7.

A diode 8 allows the current to flow from the bank of supercapacitors 4 to the bridge of static switches 2, while the diode 9 allows the direct supply of the battery voltage to the bridge of static switches 2.

The operation of the device described above is as follows.

The supercapacitors 4 are charged at a voltage of 40-50 V and kept charged by the capacitor control and charging circuit 5. When the engagement of the shoe or shoes of the brakes is activated, the control circuit controls the supply of power to the shoe 3, which receives power from the discharge of the capacitors 4. No current is required from the battery of the vehicle due to the fact that the diode 9 is not conducting and therefore interrupts the flow from the battery to the bridge of static switches.

When the voltage across the capacitors 4 drops below the battery voltage, said battery is called to supply current owing to the fact that the diode 9 starts to conduct. When the battery of the vehicle is called to supply current, however, the critical step of shoe engagement has completely ended and therefore the discharge of the battery is greatly limited.

The device described above allows to keep a greater distance between the shoe and the track, to reduce the cross-section of the cables that supply power to the shoes, since the current carried by said cables would be only the holding current, to increase in general the engagement performance by virtue of the fact that the shoe engagement step would occur by means of the current supplied by the discharge of the supercapacitors 4, which are charged at a voltage that is higher than the voltage of the battery.

Moreover, the device allows to introduce, during the release step, a sequence for demagnetizing the shoe in order to facilitate its separation from the track and allows to provide a stiffer size of springs, which allow safer separation of the shoe from the track.

In practice it has been found that the device according to the invention fully achieves the intended aim and objects, since it allows to obtain an increase in performance in the shoe engagement step, due to the fact that the current is supplied by the discharge of the bank of supercapacitors, not by the battery voltage, thus protecting the battery.

The device thus conceived is susceptible of numerous modifications and variations, all of which are within the scope of the appended claims; all the details may further be replaced with other technically equivalent elements.

What is claimed is:

1. A device for actuating shoe brakes, particularly for rail or tram vehicles, comprising means for actuating at least one brake shoe of a rail or tram vehicle, powered by battery voltage and powered by a bank of supercapacitors arranged in parallel to said actuation means, said bank of supercapacitors being controlled and charged by a dedicated circuit, which is connected to said battery, insulation means being provided in order to insulate said actuation means from said battery when said actuation means are powered by the discharge of said bank of supercapacitors.

2. The device according to claim 1, wherein said means for actuating said at least one shoe comprise a bridge of static switches.

3. The device according to claim 1, wherein said isolation means comprise at least one diode.

4. The device according to claim 1, comprising diode means which are interposed between said bank of supercapacitors and said actuation means.

5. The device according to claim 1, wherein said bank of supercapacitors is charged and kept charged by said dedicated circuit.

6. The device according to claim 1, wherein said bank of supercapacitors is charged at a voltage of 40-50 V.

7. A method for actuating shoe brakes, particularly for rail or tram vehicles, comprising the steps of:
charging a bank of supercapacitors at a voltage that is higher than the voltage of the battery that is present on board said vehicle;
supplying power, by means of the discharge of said bank of supercapacitors, to at least one brake shoe of a rail or tram vehicle;
determining whether the voltage across said bank of supercapacitors is lower than the battery voltage and, if so, delivering current from said battery to said actuation means of at least one brake shoe.
